(19) United States
(12) Patent Application Publication
(10) Pub. No.: US 2011/0123247 A1
(43) Pub. Date: May 26, 2011

(54) PRINTER WITH BRACKET FOR PAPER TRAY

(75) Inventors: CHEN-LU FAN, Tu-Cheng (TW); CHIH-KUN SHIH, Santa Clara, CA (US); CHUN-HSIEN LIN, Tu-Cheng (TW)

(73) Assignee: HON HAI PRECISION INDUSTRY CO., LTD., Tu-Cheng (TW)

(21) Appl. No.: 12/755,072

(22) Filed: Apr. 6, 2010

(30) Foreign Application Priority Data
Nov. 23, 2009 (CN) 200910310251.9

(51) Int. Cl. B41J 29/02

(52) U.S. Cl. 400/691

(57) ABSTRACT

A printer includes a main body, a bracket, a lifting mechanism, and a paper tray. The main body is capable of printing and outputting paper. The bracket is attached to the main body. The lifting mechanism is secured to the bracket and includes a retaining plate. The retaining plate is moveable between a first position, where a first distance is defined between the retaining plate and the bracket, and a second position, where a second distance is defined between the retaining plate and the bracket and is less than the first distance. The paper tray is configured for receiving the paper. The retaining plate is moved from the second position to the first position when the paper tray is inserted into the bracket, and moved from the first position to the second position when the paper tray is released.

### BACKGROUND

1. Technical Field

The present disclosure relates to a printer with a bracket for a paper tray.

2. Description of Related Art

Commonly, in office settings, many different documents are printed and output to a single tray before the documents are retrieved, such that location of a specific document can be difficult.

### BRIEF DESCRIPTION OF THE DRAWINGS

Many aspects of the embodiments can be better understood with references to the following drawings. The components in the drawings are not necessarily drawn to scale, the emphasis instead placed upon clearly illustrating the principles of the embodiments. Moreover, in the drawings, like reference numerals designate corresponding parts throughout the several views.

FIG. 1 is an exploded view of a lifting mechanism of a printer in accordance with an embodiment.

FIG. 2 is an assembled view of an embodiment of the lifting mechanism of FIG. 1.

FIG. 3 is an exploded view of a printer of in accordance with an embodiment.

FIG. 4 is an assembled view of an embodiment of the printer of FIG. 3.

FIG. 5 is similar to FIG. 4, but showing a paper tray received in a bracket.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

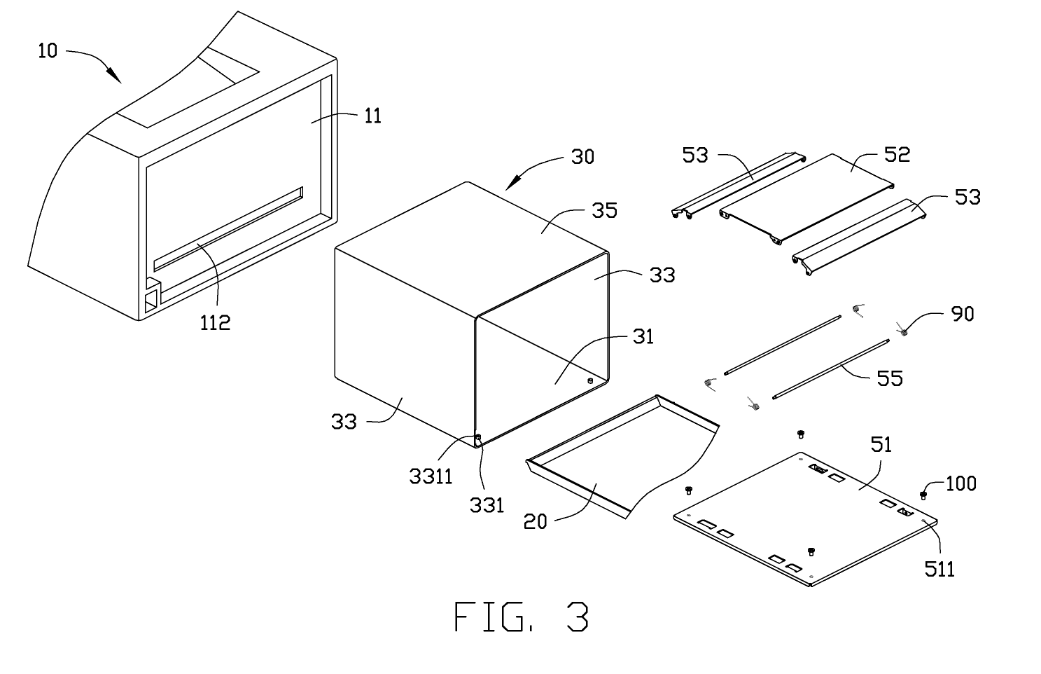

Referring to FIG. 3, a printer in accordance with an embodiment includes a main body 10, a bracket 30, and a paper tray 20.

The main body 10 is capable of printing documents and outputting paper and includes a rear wall 11. An output opening 112 is defined in the rear wall 11, for outputting the paper.

The bracket 30 includes a bottom surface 31, a top surface 35, and two sidewalls 33 connected to the bottom surface 31 and the top surface 35. In one exemplary embodiment, the bottom surface 31 is parallel to the top surface 35 and perpendicular to the sidewalls 33. Four positioning posts 331, each with a fastener hole 3311, are located on the bottom surface 31.

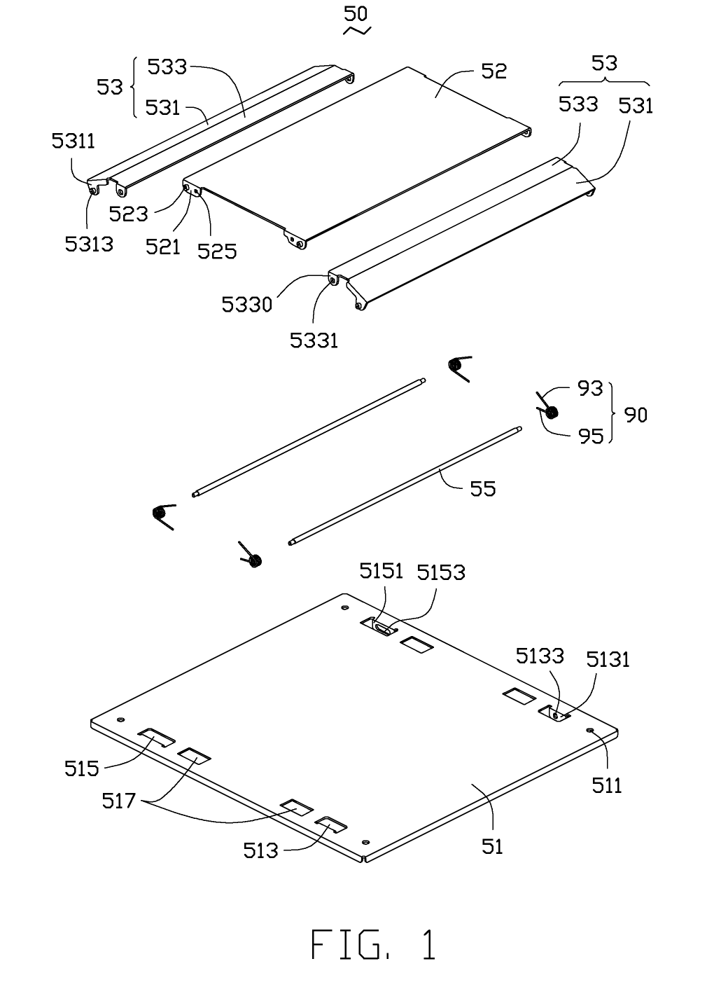

Referring to FIG. 1, a lifting mechanism 50 is configured to be installed in the bracket 30 and includes a supporting plate 51, two shafts 55, two connecting members 53, and a retaining plate 52.

The supporting plate 51 defines four through holes 511, for receiving the positioning posts 331. Two first through openings 513 and two second through openings 515 are defined in the supporting plate 51. The two first through openings 513 are adjacent to an edge of the supporting plate 51, and the two second through openings 515 are adjacent to an opposite edge thereof. Four third through openings 517 are defined in the supporting plate 51, and each third through opening 517 is adjacent to one of the first and second through openings 513, 515. Two pivot pieces 5131 are located on the supporting plate 51 adjacent to the two first through openings 513, and two positioning pieces 5151 are located on the supporting plate 51 adjacent to the two the second through openings 515. Each pivot piece 5131 defines a pivot hole 5133, and each positioning piece 5151 defines a sliding slot 5153. In one exemplary embodiment, the pivot pieces 5131 and the positioning pieces 5151 are located on a bottom surface of the supporting plate 51.

Each connecting member 53 includes a first plate portion 531 and a second plate portion 533 connected to the first plate portion 531. In one exemplary embodiment, the second plate portion 533 is set at an angle from the first plate portion 531. Two first pieces 5311 extend from opposite edges of the first plate portion 531, and a pivot pin 5313 is located on each first piece 5311. Two second pieces 5330 extend from opposite edges of the second plate portion 533, and a mounting hole 5331 is defined in each second piece 5330.

The retaining plate 52 includes two pairs of retaining pieces 521, and each pair of retaining pieces 521 extend from opposite edges of the retaining plate 52. Each retaining piece 521 has a pivot post 523 and defines a receiving hole 525.

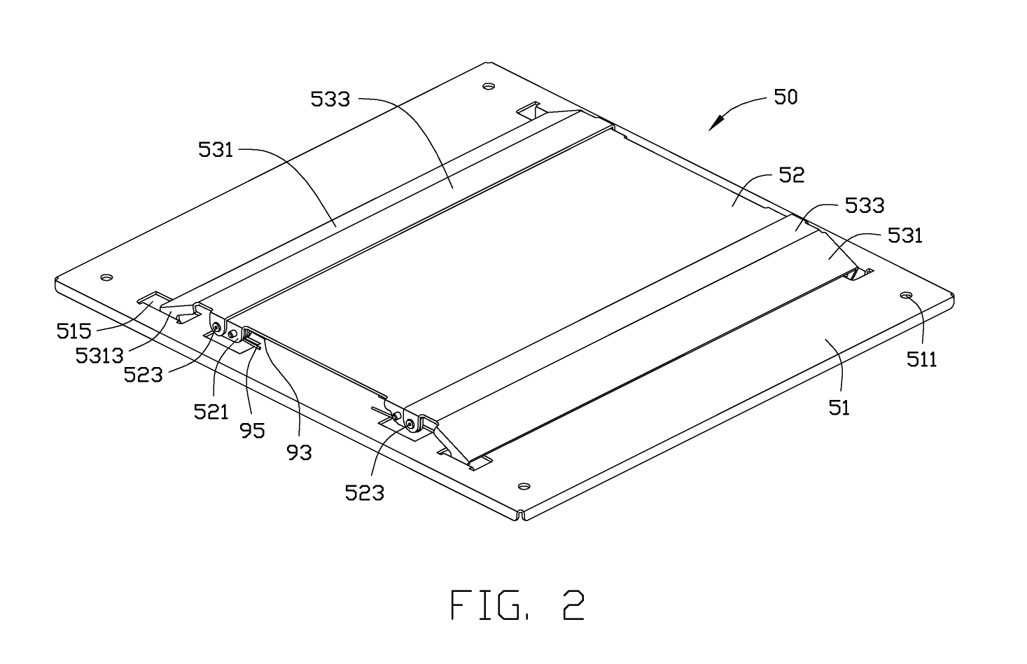

Referring to FIGS. 1-2, in assembly, two spring members 90 are disposed on each shaft 55, and each shaft 55 is received in the receiving hole 525. The pivot posts 523 of the retaining plate 52 are received in the mounting holes 5331 of the connecting members 53, and the connecting members 53 are connected to the retaining plate 52. The retaining plate 52 and the connecting members 53 are placed on the supporting plate 51. A first end 93 of each spring member 90 abuts the retaining plate 52, and a second end 95 of each spring member 90 abuts the supporting plate 51. The first pieces 5311 of the connecting members 53 are received in the second through openings 515 of the supporting plate 51, and the pivot pins 5313 are received in the sliding slots 5153 and the pivot holes 5133. The retaining plate 52 and the connecting members 53 are thus secured to the supporting plate 51, and the lifting mechanism 50 is assembled. The retaining plate 52 can be moved in a direction perpendicular to the supporting plate 51 and is parallel to the supporting plate 51 and the bottom surface 31 of the bracket 30. Each connecting member 53 can be rotated relative to the supporting plate 51 and the retaining plate 52 when the retaining plate 52 is moved.

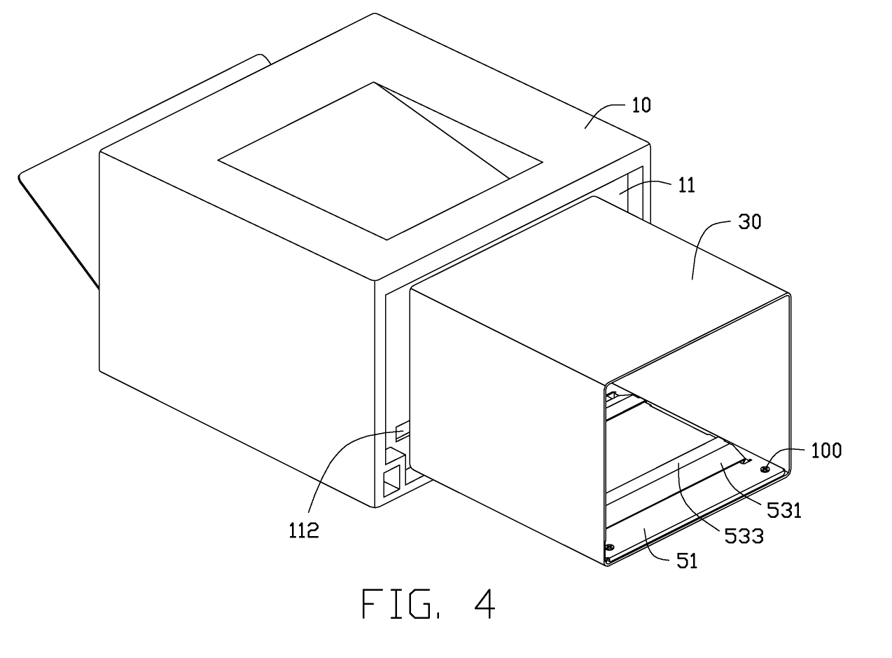

The lifting mechanism 50 is received in the bracket 30. The positioning posts 331 are received in the through holes 511, and four fasteners 100, such as screws or bolts, are received in the fastener holes 3311, to secure the supporting plate 51 to the bottom surface 31 of the bracket 30. As shown in FIG. 4, the bracket 30 with the lifting mechanism 50 is secured to the rear wall 11 of the main body 10.

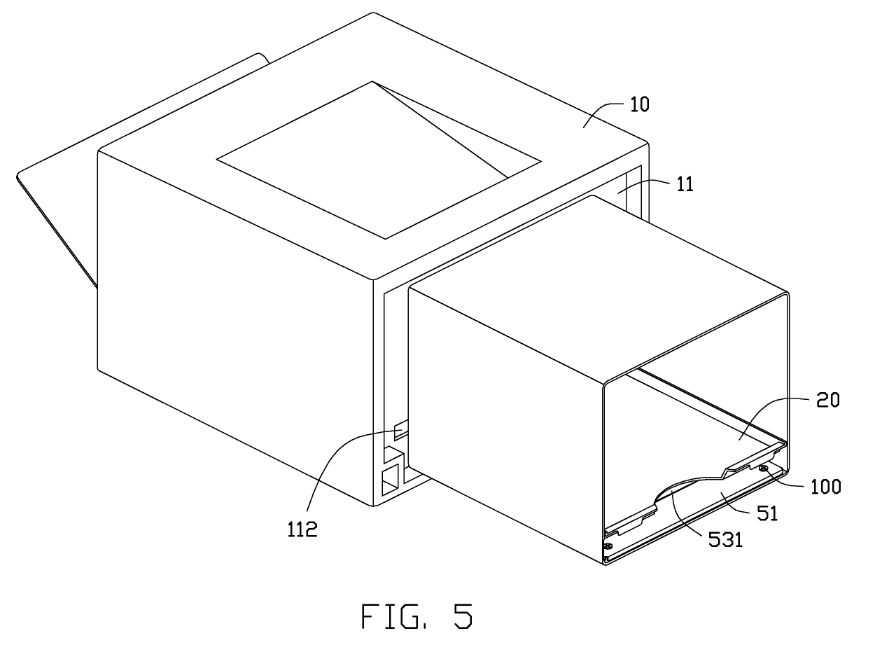

Referring to FIG. 5, in use, before the paper tray 20 is received in the bracket 30, the spring members 90 are relaxed, and the retaining plate 52 has a first position, where a first distance is defined between the retaining plate 52 and the bottom surface 31. When a paper tray 20 is received into the bracket 30 along the bottom surface 31, the paper tray 20 rotates one connecting member 53 to towards the bottom surface 31. The retaining plate 52 is moved towards the bottom surface 31 by the one connecting member 53. The spring members 90 are resiliently deformed. The other connecting member 53 is rotated towards the bottom surface 31 by the retaining plate 52, and slid relative to the bottom surface 31 and the pivot pins 5313 are slid in the sliding slots 5153. When the paper tray 20 is slid from the one connecting member 53 to the retaining plate 52, the retaining plate 52 and the connecting members 53 are moved to a second position, where a second distance between the retaining plate 52 and the bottom surface 31 is less than that the first distance. In addition, each spring member 90 has a resilient deformation, when the retaining plate 52 is in the first position, which is less than that when the retaining plate 52 is in the second position.

The paper tray 20 is released when positioned on the retaining plate 52. The spring members 90 are biased to move the retaining plate 52 from the second position to the first position and lift up the paper tray 20. The connecting members 53 are rotated away from the bottom surface 31 until the retaining plate 52 is positioned in the first position.

When another paper tray 20 is to be received in the bracket 30, it can be slid along the bottom surface 31 below the originally inserted paper tray 20. The second paper tray 20 moves the retaining plate 52 from the first position to the second position by pressing the one connecting member 53. At the same time, the originally inserted paper tray 20 is located on the second paper tray 20. When the second paper tray 20 is released, the retaining plate 52 is moved from the second position to the first position, to lift up the two paper trays 20.

Repeating, a plurality of paper trays 20 can be received in the bracket 30 if needed.

The paper tray 20 in a top position can receive paper output from the output opening 112 after documents are printed by the main body 10. Before another document is printed, the paper tray 20 with the paper at the top position can be pulled out from the bracket 30. The paper is taken out from the paper tray 20, and then the paper tray 20 can be also received into the bracket 30 along the bottom surface 31.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A printer, comprising:
a main body capable of printing and outputting paper;
a bracket attached to the main body;
a lifting mechanism secured to the bracket and comprising a retaining plate, the retaining plate is moveable between a first position, where a first distance is defined between the retaining plate and the bracket, and a second position, where a second distance is defined between the retaining plate and the bracket and is less than the first distance; and
a paper tray configured for receiving the paper;
wherein the retaining plate is capable of being moved from the second position to the first position when the paper tray is inserted in the bracket, and moved from the first position to the second position when the paper tray is released.

2. The printer of claim 1, wherein the lifting mechanism further comprises a plurality of spring members located between the retaining plate and the bracket; and each spring member has a resilient deformation, when the retaining plate is in the second position, which is greater than that in the first position.

3. The printer of claim 2, wherein the lifting mechanism further comprises two connecting members connected to the retaining plate; and the two connecting members are rotatable relative to the retaining plate.

4. The printer of claim 3, wherein the lifting mechanism further comprises a supporting plate secured to the bracket; and the connecting members are rotatable relative to the supporting plate.

5. The printer of claim 4, wherein each connecting member comprises a first plate portion connected to the retaining plate and a second plate portion at an angle to the first plate portion; and the second plate portion is connected to the supporting plate.

6. The printer of claim 5, wherein the retaining plate comprises a plurality of pivot posts; the first plate portions of the connecting members define a plurality of mounting holes rotatably receiving the corresponding pivot posts.

7. The printer of claim 5, wherein the supporting plate defines two pivot holes; at least one of the two connecting members comprises two pivot pins; and the two pivot pins are rotatably received in the two pivot holes.

8. The printer of claim 5, wherein the supporting plate defines two sliding slots; and at least one of the two connecting members comprises two pivot pins; and the two pivot pins are slidably received in the two sliding slots.

9. The printer of claim 4, wherein a shaft is secured to the retaining plate; and the spring members are secured on the shaft.

10. The printer of claim 9, wherein each spring member comprises a first end abutting the retaining plate, and a second end abutting the supporting plate.

11. A printer, comprising:
a main body capable of printing and outputting paper;
a bracket attached to the main body and comprising a bottom surface;
a lifting mechanism secured to the bracket and comprising a retaining plate parallel to the bottom surface, a plurality of spring members disposed between the retaining plate and the bottom surface; and
a paper tray configured for receiving the paper;
wherein the retaining plate is capable of being moved towards the bottom surface to deform the spring members when the paper tray is inserted into the bracket.

12. The printer of claim 11, wherein the lifting mechanism further comprises two connecting members connected to the retaining plate; and the two connecting members are rotatable relative to the retaining plate.

13. The printer of claim 12, wherein the lifting mechanism further comprises a supporting plate secured to the bracket; and the connecting members are connected to the supporting plate.

14. The printer of claim 13, wherein each connecting member comprises a first plate portion connected to the retaining plate and a second plate portion at an angle to the first plate portion; and the second plate portion is connected to the supporting plate.

15. The printer of claim 13, wherein the retaining plate comprises a plurality of pivot posts; and the first plate portions of the connecting members define a plurality of mounting holes rotatably receiving the corresponding pivot posts.

16. The printer of claim 14, wherein the supporting plate defines two pivot holes; at least one of the two connecting members comprises two pivot pins; and the two pivot pins are rotatably received in the two pivot holes.

17. The printer of claim 14, wherein the supporting plate defines two sliding slots; and
at least one of the two connecting members comprises two pivot pins; and the pivot pins are slidably received in the two sliding slots.

18. The printer of claim 13, wherein a shaft is secured to the retaining plate; and the spring members are secured on the shaft.

19. The printer of claim 18, wherein each spring member comprises a first end abutting the retaining plate, and a second end abutting the supporting plate.

20. The printer of claim 13, wherein a distance is defined between the retaining plate and the supporting plate exceeding a height of the paper tray.
